(19) United States
(12) Patent Application Publication
(10) Pub. No.: US 2005/0253307 A1
(43) Pub. Date: Nov. 17, 2005

(54) Method of patterning a conductive layer on a substrate

(75) Inventor: Sidlgata V. Sreenivasan, Austin, TX (US)

Correspondence Address: MOLECULAR IMPRINTS, INC.;KENNETH C. BROOKS, PO BOX 81536, AUSTIN, TX, 78708-1536, US

(73) Assignee: MOLECUALR IMPRINTS, INC., Austin, TX (US)

(21) Appl. No.: 10/843,194

(22) Filed: May 11, 2004

(51) Int. Cl. B29C 35/08; B29C 71/02; B29C 59/02

(52) U.S. Cl. 264/494; 264/236; 264/104; 264/105; 264/310; 264/293

(57) ABSTRACT

The present invention includes a method of patterning a conductive layer on an substrate that features creating a multi-layered structure by solidifying a liquid layer to have a pattern including protrusions and recessions, defining a solidified layer, and forming, upon the patterned layer, a liquid conformal layer. The liquid conformal layer is reflowed to provide a substantially smooth surface before solidification. In one embodiment of the invention, the liquid conformal layer may include a conductive component. By ensuring that the conformal layer forms a smooth, if not, planar surface, control over the dimensions of the resulting features is maintained. As a result, a single level layer of high density multiple conductive elements may be fabricated.

### BACKGROUND OF THE INVENTION

The field of invention relates generally to micro-fabrication of structures. More particularly, the present invention is directed to a method for creating positive tone structures employing imprint lithography.

The earliest integrated circuits required a limited number of devices having dimensions that are large by present day standards, typically necessitating only a single layer of metal. Moreover, the pitch of the metal pattern did not limit the device packing density of the integrated circuit. As the devices became smaller and the number of devices employed in a circuit became greater, metal patterns of the integrated circuit limited the device density. These problems were overcome, in large part, by forming multi-level metal patterns.

However, single level metallization has proved desirable where device density is not a constraint, for example, in the manufacture of large displays. The simplicity of the single level metallization and reduced cost of manufacture devices employing the same makes single level metallization a desired design characteristic when forming certain integrated circuits.

It is desired, therefore, to provide an improved method for forming circuits from single level metallization.

### SUMMARY OF THE INVENTION

The present invention includes a method of forming a patterned conductive layer on a substrate that features creating a multi-layered structure by solidifying a liquid layer to have a pattern including electrically insulative protrusions and recessions, defining a dielectric patterned layer. Formed upon the dielectric patterned layer is an electrically conductive liquid conformal layer. The electrically conductive liquid conformal layer is solidified to form a solidified electrically conductive conformal layer. Portions of the solidified electrically conductive conformal layer are removed to expose regions thereof. The regions are electrically insulated from adjacent regions of the solidified conductive conformal layer by one of the protrusions. The pattern of the electrically conductive layer is a function of, if not defined by, the electrically insulative protrusions and recession of the dielectric patterned layer. As a result, a single level layer of high density multiple conductive elements may be fabricated. These and other embodiments are discussed more fully below.

### BRIEF DESCRIPTION OF THE DRAWINGS

FIG. 1 is a perspective view of a lithographic system in accordance with the present invention;

FIG. 2 is a simplified elevation view of a lithographic system, shown in FIG. 1, employed to create a patterned imprinting layer in accordance with the present invention;

FIG. 3 is a simplified representation of material from which a patterned imprinting layer, shown in FIG. 2, is comprised before being polymerized and cross-linked in accordance with the present invention;

FIG. 4 is a simplified representation of cross-linked polymer material into which the material shown in FIG. 3 is transformed after being subjected to radiation in accordance with the present invention;

FIG. 5 is a simplified elevation view of an imprint device spaced-apart from the patterned imprinting layer, shown in FIG. 1, after patterning in accordance with the present invention;

FIG. 6 is a simplified elevation view of formation of a multi-layered structure on a solidified imprinting layer, shown in FIG. 5, by deposition of a conformal layer, adjacent to the patterned imprinting layer, employing a mold in accordance with one embodiment of the present invention;

FIG. 7 is a simplified elevation view after a blanket etch of the multi-layered structure, shown in FIG. 6, to form a crown surface in the conformal layer with portions of the patterned imprinting layer being exposed in accordance with one embodiment of the present invention;

FIG. 8 is a simplified elevation view showing formation of a planarization layer in accordance with an alternate embodiment of the present invention;

FIG. 9 is a simplified plan view of a radiation source employed in the lithographic system shown in FIG. 1, depicting dual radiation sources;

FIG. 10 is a simplified plan view of a radiation source employed in the lithographic system, shown in FIG. 1, depicting single radiation source;

FIG. 11 is a cross-sectional view of a substrate shown in FIGS. 1, 2, 5, 6, 7 and 8, showing an infra-red absorption layer in accordance with the present invention;

FIG. 12 is a cross-sectional view of a substrate shown in FIGS. 1, 2, 5, 6, 7 and 8, showing an infra-red absorption layer in accordance with an alternate embodiment of the present invention;

FIG. 13 is a cross-sectional view showing a release layer and a planarization layer that may be employed in accordance with the present invention; and

FIG. 14 is a cross-sectional view showing a release layer applied to a planarization mold shown in FIG. 12.

### DETAILED DESCRIPTION OF THE INVENTION

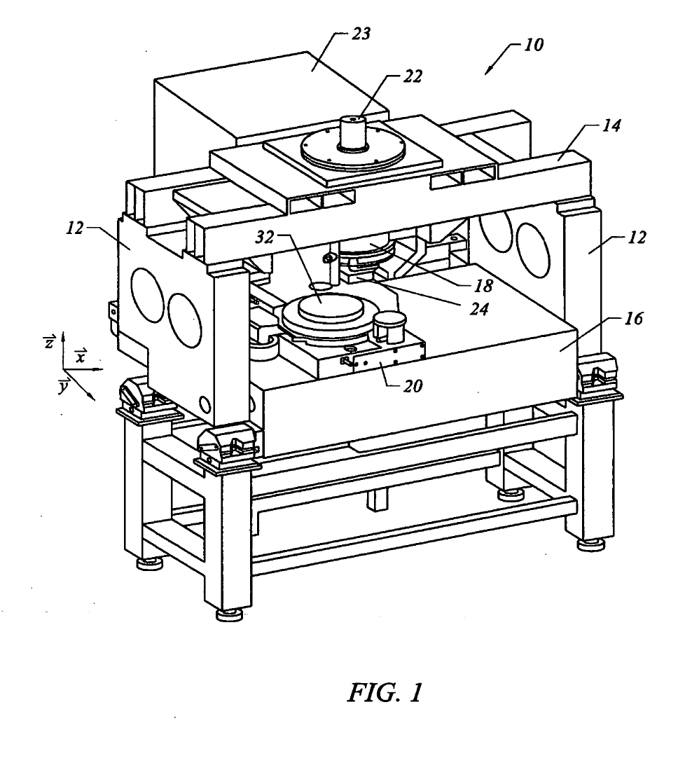

FIG. 1 depicts a lithographic system 10 in accordance with one embodiment of the present invention that includes a pair of spaced-apart bridge supports 12 having a bridge 14 and a stage support 16 extending therebetween. Bridge 14 and stage support 16 are spaced-apart. Coupled to bridge 14 is an imprint head 18, which extends from bridge 14 toward stage support 16. Disposed upon stage support 16 to face imprint head 18 is a motion stage 20. Motion stage 20 is configured to move with respect to stage support 16 along X- and Y-axes and may provide movement along the Z-axis as well. A radiation source 22 is coupled to system 10 to impinge actinic radiation upon motion stage 20. As shown, radiation source 22 is coupled to bridge 14 and includes a power generator 23 connected to radiation source 22.

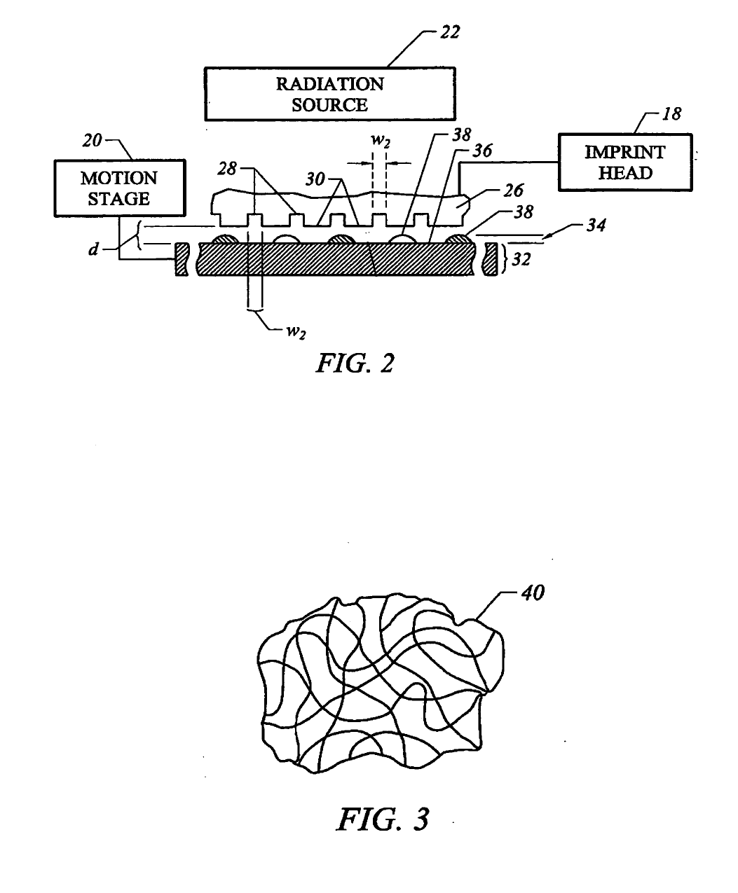

Referring to both FIGS. 1 and 2, connected to imprint head 18 is a template 24 having a patterned mold 26 thereon. An exemplary template 24 is shown in U.S. Pat. No. 6,696,220. Patterned mold 26 includes a plurality of features defined by a plurality of spaced-apart recesses 28 and projections 30. Projections 30 have a width W₁, and recesses 28 have a width W₂, both of which are measured in a direction that extends transversely to the Z axis. The plurality of features defines an original pattern that forms the basis of a pattern to be transferred into a substrate 32 positioned on motion stage 20. To that end, imprint head 18 is adapted to move along the Z-axis and to vary a distance “d” between patterned mold 26 and substrate 32. Alternatively, or in conjunction with imprint head 18, motion stage 20 may move template 24 along the Z-axis. In this manner, the features on patterned mold 26 may be imprinted into a flowable region of substrate 32, discussed more fully below. Radiation source 22 is located so that patterned mold 26 is positioned between radiation source 22 and substrate 32. As a result, patterned mold 26 is fabricated from material that allows it to be substantially transparent to the radiation produced by radiation source 22. An exemplary system is available under the trade name IMPRIO 100™ from Molecular Imprints, Inc. having a place of business at 1807-C Braker Lane, Suite 100, Austin, Tex. 78758. The system description for the IMPRIO 100™ is available at www.molecularimprints.com and is incorporated herein by reference.

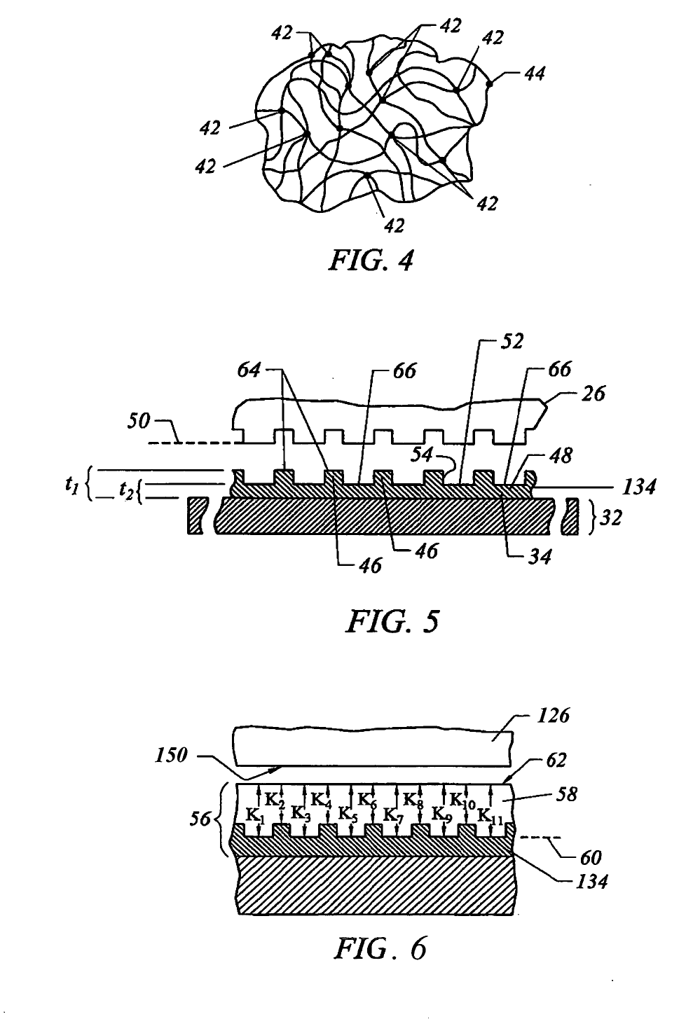

Referring to both FIGS. 2 and 3, a flowable region, such as an imprinting layer 34, is disposed on a portion of surface 36 that presents a substantially planar profile. In the present embodiment, the flowable region is deposited as a plurality of spaced-apart discrete droplets 38 of a material 40 on substrate 32, discussed more fully below. Material 40 is substantially silicon-free and may be selectively polymerized and cross-linked to record an inverse of the original pattern therein, defining a recorded pattern. Material 40 is shown in FIG. 4 as being cross-linked at points 42, forming cross-linked polymer material 44.

Referring to FIGS. 2, 3 and 5, the pattern recorded in imprinting layer 34 is produced, in part, by mechanical contact with patterned mold 26. To that end, the distance “d” is reduced to allow imprinting layer 34 to come into mechanical contact with patterned mold 26, spreading droplets 38 so as to form imprinting layer 34 with a contiguous formation of material 40 over surface 36. In one embodiment, distance “d” is reduced to allow sub-portions 46 of imprinting layer 34 to ingress into and fill recesses 28.

In the present embodiment, sub-portions 48 of imprinting layer 34 in superimposition with projections 30 remain after the desired, usually minimum distance “d,” has been reached, leaving sub-portions 46 with a thickness t, and sub-portions 48 with a thickness t₂. Thickness t₂ is referred to as a residual thickness. Thicknesses “t₁“and “t₂” may be any thickness desired, dependent upon the application. The total volume contained in droplets 38 may be such so as to minimize, or to avoid, a quantity of material 40 from extending beyond the region of surface 36 in superimposition with patterned mold 26, while obtaining desired thicknesses t₁ and t₂.

Referring to FIGS. 2, 3, and 4, after a desired distance “d” has been reached, radiation source 22 produces actinic radiation that polymerizes and cross-links material 40, forming cross-linked polymer material 44. As a result, the composition of imprinting layer 34 transforms from material 40 to material 44, which is a solid. Specifically, material 44 is solidified to form solidified imprinting layer 134 with a side having a shape that conforms to a shape of a surface 50 of patterned mold 26, shown more clearly in FIG. 5. As a result, solidified imprinting layer 134 is formed having recessions 52 and protrusions 54. After formation of solidified imprinting layer 134, distance “d” is increased so that patterned mold 26 and solidified imprinting layer 134 are spaced-apart. Typically, this process is repeated several times to pattern different regions (not shown) of substrate 32, referred to as a step and repeat process. An exemplary step and repeat process is disclosed in published U.S. patent application No. 2004/0008334, which is assigned to the assignee of the present invention and is incorporated by reference herein.

Referring to FIGS. 1, 2 and 3, the characteristics of material 40 are important to efficiently pattern substrate 32 in light of the unique deposition process employed. As mentioned above, material 40 is deposited on substrate 32 as a plurality of discrete and spaced-apart droplets 38. The combined volume of droplets 38 is such that the material 40 is distributed appropriately over an area of surface 36 where imprinting layer 34 is to be formed. In this fashion, the total volume of imprinting material 40 in droplets 38 defines the distance “d” to be obtained so that the total volume occupied by material 40 in the gap defined between patterned mold 26 and the portion of substrate 32 in superimposition therewith once the desired distance “d” is reached is substantially equal to the total volume of material 40 in droplets 38. As a result, imprinting layer 34 is spread and patterned concurrently with the pattern being subsequently set by exposure to radiation, such as ultraviolet radiation. To facilitate the deposition process, it is desired that material 40 have certain characteristics to provide rapid and even spreading of material 40 in droplets 38 over surface 36 so that the all thicknesses t₁ are substantially uniform and all residual thicknesses t₂ are substantially uniform.

An exemplary composition for material 40 is silicon-free and consists of the following:

### COMPOSITION 1

### isobornyl acrylate

### n-hexyl acrylate

### ethylene glycol diacrylate

### 2-hydroxy-2-methyl-1-phenyl-propan-1-one

In COMPOSITION 1, isobornyl acrylate comprises approximately 55% of the composition, n-hexyl acrylate comprises approximately 27%, ethylene glycol diacrylate comprises approximately 15% and the initiator 2-hydroxy-2-methyl-1-phenyl-propan-1-one comprises approximately 3%. The initiator is sold under the trade name DAROCUR® 1173 by CIBA® of Tarrytown, N.Y. The above-identified composition also includes stabilizers that are well known in the chemical art to increase the operational life of the composition. To provide suitable release properties, COMPOSITION 1 may be employed with a template treated to have a mold surface that is hydrophobic and/or low surface energy, e.g., an a priori release layer.

Referring to FIGS. 3 and 5, to improve the release properties of patterned mold 26 and solidified imprinting layer 134 and to ensure that solidified imprinting layer 134 does not adhere to patterned mold 26, an additive may be included in COMPOSITION 1. To that end, material 40 may include, as an additive, a surfactant. For purposes of this invention a surfactant is defined as any molecule, one tail of which is hydrophobic. Surfactants may be either fluorine-containing, e.g., include a fluorine chain, or may not include any fluorine in the surfactant molecule structure. An exemplary surfactant is available under the trade name ZONYL® FSO-100 from DUPONT™ that has a general structure of R₁R₂, where R₁═F(CF₂CF₂)_{Y} with y being in a range of 1 to 7, inclusive, and R₂═CH₂CH₂O(CH₂CH₂O)_{X} H where X is in a range of 0 to 15, inclusive. This provides material 40 with the following composition:

### COMPOSITION 2

### isobornyl acrylate

### n-hexyl acrylate

### ethylene glycol diacrylate

### 2-hydroxy2-methyl1-phenyl-propan1-one

### R_{f}CH₂CH₂O(CH₂CH₂O)_{X}H,

The ZONYL® FSO-100 additive comprises less than 1% of the composition with the relative amounts of the remaining components being as discussed above with respect to COMPOSITION 1. However, the percentage of ZONYL® FSO-100 may be greater than 1%.

Each of COMPOSITIONS 1 and 2 are electrically non-conductive, i.e., COMPOSITIONS 1 and 2 are dielectric materials. As a result, COMPOSITIONS 1 and 2 may be employed to form a single level metallized device. Specifically, by forming solidified imprinting layer 134 with a desired pattern, solidified imprinting layer 134 an electrically conductive layer may be disposed adjacent to solidified imprinting layer 134. In this manner, a desired single level electrical circuit may be formed.

Referring to FIG. 5, COMPOSITIONS 1 and 2 may be doped with a conductive component, such as carbon-black and graphite, to form a conductive material. In a further embodiment COMPOSITIONS 1 and 2 may be formed from, or doped with, a conductive polymer including, but not limited to, organic polymers, copolymers, and conjugated polymers, such as poly(para-phenylene), polyaniline, and poly(p-phenylenevinylene). The conductive material would be employed to form a multi-layered structure 56 by forming a conductive conformal layer 58 adjacent to solidified imprinting layer 134. Specifically, the conductive material may be deposited adjacent to solidified imprinting layer 134 using any known technique to form conformal layer 58, such as the technique discussed above with respect to deposition of material 40. Alternatively, the conductive material may be deposited adjacent to solidified imprinting layer 134 employing spin-coating techniques, discussed more fully below.

Referring to both FIGS. 2 and 6, when deposition occurs employing the techniques discussed above, patterned mold 26 is replaced with a planarization mold 126. Planarization mold 126 has a substantially smooth, if not planar, surface 150. Surface 150 contacts droplets 38, causing the same to spread in a manner discussed above, excepting that conformal layer 58 is formed having a smooth, if not substantially planar, surface referred to as a normalization surface 62. The shape of normalization surface 62 matches the profile of surface 150. Typically, planarization mold 126 is an optical flat that has sufficient area to concurrently planarize all regions of substrate 32 that includes conductive material employed to form conformal layer 58. Thereafter, the conductive material in conformal layer 58 is solidified and planarization mold 126 is separated from conformal layer 58. In this manner, conformal layer 58 includes first and second opposed sides. First side 60 faces imprinting layer 134 and has a profile complementary to the profile of the imprinting layer 134. The second side faces away from imprinting layer 134, forming normalization surface 62.

As a result of the topography of normalization surface 62, distances k₂, k₄, k₆, k₈ and k₁₀ between the apex 64 of each of protrusions 54 and normalization surface 62 are substantially the same. Similarly, the distances k₁, k₃, k₅, k₇, k₉ and k₁₁ between a nadir surface 66 of each of recessions 52 and normalization surface 62 are substantially the same.

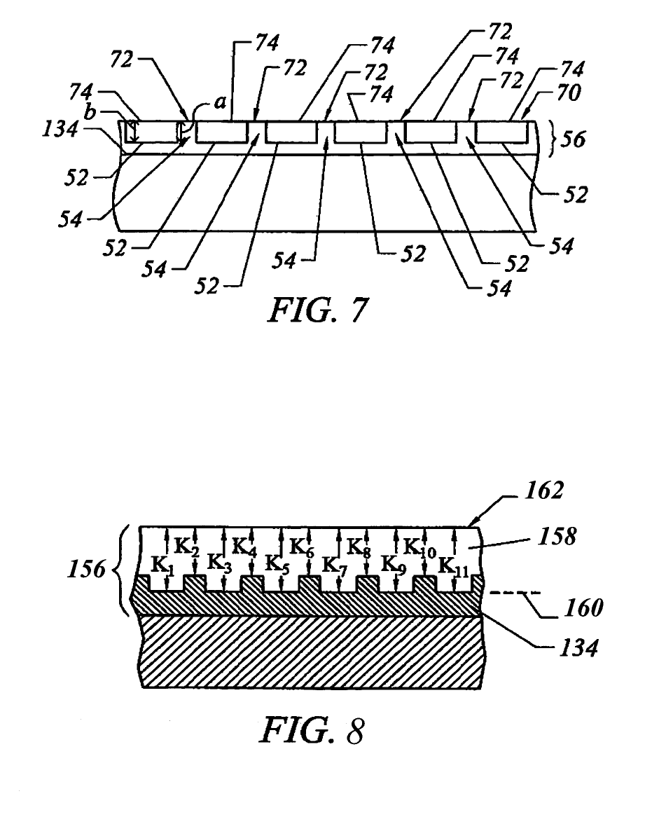

Referring to FIGS. 6 and 7, after formation of normalization surface 62, a blanket etch is employed to remove portions of conformal layer 58 to provide multi-layered structure 56 with a crown surface 70. For example and without limitation, the blanket etch may be achieved in a system available from LAM Research 9400SE obtained from Lam Research, Inc. of Fremont, Calif. In this manner, normalization surface 62 is subjected to an isotropic halogen reactive ion etch (“RIE”) rich in fluorine, i.e., wherein at least one of the precursors was a fluorine-containing material, for example, and without limitation, a combination of CHF₃ and O₂. Other suitable halogen compounds include, for example, and without limitation, CF₄. Normalization surface 62 is subjected to the blanket etch sufficient to expose crown surface 70.

Crown surface 70 is defined by an exposed surface 72 of each of electrically insulative protrusions 54 and upper surfaces of electrically conductive portions 74 that remain on conformal layer 58 after the blanket etch. The composition of conformal layer 58 is such that when the blanket etch is applied to conformal layer 58, crown surface 70 is provided with a substantially planar profile. That is, the thickness of protrusions 54, shown as “a”, is substantially the same as the thickness of portions 74, shown as “b”. An exemplary blanket etch may be a plasma etch process employing a fluorine-based chemistry. In this manner, single level circuits may be formed consisting of electrically conductive portions 74 separated by electrically insulative protrusions 54.

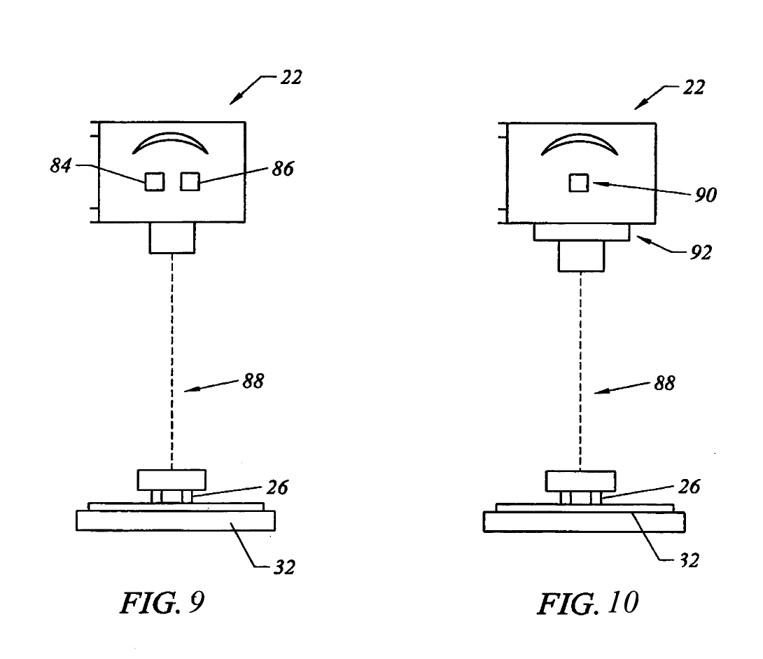

Referring to FIGS. 6 and 9, as discussed above, single level circuits may be formed by formation of conformal layer 58 employing spin-on and thermal curing techniques. To that end, exemplary material that may be employed to form conformal layer 158 includes a silicon-containing composition that is doped with a conductive material, such as polyanyline, carbon black and graphite. An exemplary silicon-containing composition includes a silicone resin, a cross-linking agent, a catalyst, and a solvent.

The silicone resin is process compatible, satisfying ionic, purity, and by-product contamination requirements desired. The cross-linking agent is included to cross-link the silicone resin, providing conformal layer 158 with the properties to record a pattern thereon having very small feature sizes, i.e., on the order of a few nanometers. To that end, the catalyst is provided to produce a condensation reaction in response to thermal energy, e.g., heat, causing the silicone resin and the cross-linking agent to polymerize and to cross-link, forming a cross-linked polymer material. The solvent selected is compatible with the silicone resin and represents the remaining balance of the conductive material. It is desired that the solvent minimize, if not avoid, causing distortions in solidified imprinting layer 134 due, for example, to swelling of solidified imprinting layer 134.

The silicone resin can be any alkyl and/or aryl substituted polysiloxane, copolymer, blend or mixture thereof. Examples of a silicone resin include ultraviolet (UV) curable sol-gels; UV curable epoxy silicone; UV curable acrylate silicone; and UV curable silicone via thiolene chemistry; and non-cured materials, such as hydrogen silsesquioxanes; and poly(meth)acrylate/siloxane copolymers. Preferably, a hydroxyl-functional polysiloxane is used, such as a hydroxyl-functional organo-siloxane, with examples of organo-siloxanes including methyl, phenyl, propyl and their mixtures. The silicone resin may be present in the conductive composition in amounts of approximately 2% to 40% by weight, depending on the thicknesses desired for conformal layer 158. An exemplary example of a hydroxyl-functional polysiloxane used in the present invention is a silicon T-resin intermediate available from Dow Corning® (Midland, Mich.) under the trade name Z-6018.

The cross-linking agent is a compound that includes two or more polymerizable groups. The cross-linking agent may be present in the conductive composition in amounts of approximately 2% to 50% by weight in relation to the quantity of silicone resin present. Typically, the cross-linking agent is present in the conductive composition in an amount of approximately 20% to 30%. An exemplary example of a cross-linking agent used in the present invention is a hexamethoxymethylmelamine(HMMM)-based aminoplast cross-linking agent available from Cytec Industries, Inc. (West Paterson, N.J.) under the trade name CYMEL 303ULF.

The catalyst may be any component that catalyzes a condensation reaction. Suitable catalysts may include, but are not limited to, acidic compounds, such as sulfonic acid. The catalyst may be present in the conductive material in amounts of approximately 0.05% to 5% by weight in relation to the silicone resin present. Typically, the catalyst is present in the conductive material in an amount of approximately 1% to 2%. An exemplary example of a catalyst used in the present invention is toluenesulfonic acid available from Cytec Industries, Inc. (West Paterson, N.J.) under the trade name CYCAT 4040.

For the balance of the composition, a solvent is utilized. The solvent can be any solvent or combination of solvents that satisfies several criteria. As mentioned above, the solvent should not cause solidified imprinting layer 134 to swell. In addition, the evaporation rate of the solvent should be established so that a desired quantity of the solvent evaporates as a result of the spin-coating process, while providing sufficient viscosity to facilitate planarization of the conductive material in furtherance of forming conformal layer 158. Suitable solvents may include, but are not limited to, alcohol, ether, a glycol or glycol ether, a ketone, an ester, an acetate and mixtures thereof. The solvent may be present in the conductive material used to form conformal layer 158 in amounts of approximately 60% to 98% by weight, dependent upon the desired thicknesses of conformal layer 158. An exemplary example of a solvent used in the present invention is methyl amyl ketone available from Aldrich Co. (St. Louis, Mo.) under the trade name MAK.

In a further embodiment, the composition of conformal layer 158 is altered to include an epoxy-functional silane coupling agent to improve the cross-linking reaction and to improve the rate of cross-linking. Examples of epoxy-functional silanes may include glycidoxymethyltrimethoxysilane, 3-glycidoxypropyltrihydroxysilane, 3-glycidoxypropyldimethylhydroxysilane, 3-glycidoxypropyltrimeth oxysilane, 2,3-epoxypropyltrimethoxysilane, and the like. The epoxy-functional silane may be present in conformal layer 158 in amounts of approximately 2% to 30% by weight of conductive compound in relation to the silicone resin and typically in an amount of 5% to 10%. An exemplary example of epoxy-functional silane used in the present invention is gamma-glycidoxypropyltrimethoxysilane available from GE Silicone/OSi Specialty (Wilton, Conn.) under the trade name A187.

Exemplary compositions from which to form conformal layer 158 are as follows:

### COMPOSITION 3

### hydroxyl-functional polysiloxane

### hexamethoxymethylmelamine

### toluenesulfonic acid

### methyl amyl ketone

### COMPOSITION 4

### hydroxyl-functional polysiloxane

### hexamethoxymethylmelamine

### gamma-glycidoxypropyltrimethoxysilane

### toluenesulfonic acid

### methyl amyl ketone

In COMPOSITION 3, hydroxyl-functional polysiloxane comprises approximately 4% of the composition, hexamethoxymethylmelamine comprisies approximately 0.95%, toluenesulfonic acid comprises approximately 0.05% and methyl amyl ketone comprises approximately 95%. In COMPOSITION 4, hydroxyl-functional polysiloxane comprises approximately 4% of the composition, hexamethoxymethylmelamine comprisies approximately 0.7%, gamma-glycidoxypropyltrimethoxysilane comprisies approximately 0.25%, toluenesulfonic acid comprises approximately 0.05%, and methyl amyl ketone comprises approximately 95%.

Both COMPOSITIONS 3 and 4 are made up of at least 4% of the silicone resin. Upon curing, however, the quantity of silicon present in conformal layer 158 is at least 5% by weight and typically in a range of 20% or greater. Specifically, the quantity and the composition of the solvent present in COMPOSITIONS 3 and 4 are selected so that a substantial portion of the solvent evaporates during spin-coating application of the COMPOSITION 3 or 4 on solidified imprinting layer 134. In the present exemplary conductive material, approximately 90% of the solvent evaporates during spin-coating. Upon exposing the conductive material to thermal energy, the remaining 10% of the solvent evaporates, leaving conformal layer 158 with approximately 20% silicon by weight.

An exemplary method of forming conformal layer 158 includes spinning-on approximately 4 mL of the conductive material deposited proximate to a center of solidified imprinting layer 134. To that end, substrate 32 is spun at 1000 rev/min for 1 min by placing substrate 32 on a hot plate. Thereafter, the conductive material is subjected to thermal energy by baking at 150° C. for 1 min. This produces the conductive material from which conformal layer 158 is formed with thickness variations of 20 nm or less. Were it desired to increase the thickness of the solidified conductive layer, e.g., to provide the solidified conductive layer with a thickness of 200 nm, the aforementioned spin-coating and curing processes are simply repeated. As a result, the solvent employed is selected so as not to remove, “wash away,” the conductive material in a well-cured conformal layer 158.

Referring to FIG. 8, the spin-coating and curing processes provide conformal layer 158 first and second opposed sides. First side 160 faces imprinting layer 134 and has a profile complementary to the profile of imprinting layer 134. The second side faces away from imprinting layer 134 forming normalization surface 162, which is substantially smooth and typically planar and without necessitating implementation of planarization mold 126. In this manner, normalization surface 162 provides solidified conformal layer 158 with a substantially normalized profile. It is believed that normalization surface 162 is provided with a smooth, e.g., substantially planar, topography by ensuring that COMPOSITIONS 3 and 4 have a glass transition temperature lower than the curing temperature. Specifically, it is desired that the temperature difference between the glass transition temperature and the curing temperature be sufficient to allow the conductive material to reflow during curing to maximize smoothness, e.g., planarity of normalization surface 162, in a minimum amount of time. For example, the COMPOSITIONS 3 and 4 each have a glass transition temperature of approximately 50° C. and a curing temperature of 150° C. As a result, of the topography of normalization surface 162, the distances k₂, k₄, k₆, k₈ and k₁₀ between apex 64 of each of protrusions 54 and normalization surface 162 are substantially the same. Similarly, the distances k₁, k₃, k₅, k₇, k₉ and k₁₁ between nadir surface 66 of each of recessions 52 and normalization surface 162 are substantially the same.

It has been found that additional planarization may be desired when forming conformal layer 158. To that end, the silicon-containing conductive material may be deposited as a plurality of droplets as discussed above with respect to forming conformal layer 58, or may be spun-on. After deposition of the silicon-containing conductive material, planarization mold 126 is employed to further planarize normalization surface 162. Thereafter, the silicon-containing conductive material is solidified and planarized mold 126 is separated from conformal layer 158. Thereafter, conformal layer 158 is processed as discussed above to form single level circuits.

Referring to both FIGS. 2, 6 and 9, it may be desired to implement a step and repeat planarization process when forming conformal layer 58. To that end, radiation source 22 may be selected to provide actinic radiation to effectuate cross-linking using both infrared (IR) radiation and ultraviolet radiation. An exemplary radiation source 22 may include multiple sources, each of which produces a single range of wavelengths of radiation, and is shown including two radiation sources 84 and 86. Radiation source 84 may be any known in the art capable of producing IR radiation, and radiation source 86 may be any known in the art capable of producing actinic radiation employed to polymerize and to cross-link material in droplets 38, such as UV radiation. Specifically, radiation produced by either of sources 84 and 86 propagates along optical path 88 toward substrate 32. A circuit (not shown) is in electrical communication with radiation sources 84 and 86 to selectively allow radiation in the UV and IR spectra to impinge upon substrate 32.

Referring to FIG. 10, alternatively, radiation source 22 may include a single radiation source that produces multiple ranges of wavelength, which may be selectively controlled to impinge upon substrate 32 sequentially or concurrently. An exemplary radiation source 22 consists of a single broad spectrum radiation source 90 that produces UV and IR radiation, which may consist of a mercury (Hg) lamp. To selectively impinge differing types of radiation upon substrate 32, a filtering system 92 is utilized. Filtering system 92 comprises a high pass filter (not shown) and a low pass filter (not shown), each in optical communication with radiation source 90. Filtering system 92 may position the high pass filter (not shown) such that optical path 88 comprises IR radiation or filtering system 92 may position the low pass filter (not shown) such that optical path 88 comprises UV radiation. The high pass and low pass filters (not shown) may be any known in the art, such as interference filters comprising two semi-reflective coatings with a spacer disposed therebetween. The index of refraction and the thickness of the spacer determine the frequency band being selected and transmitted through the interference filter. Therefore, the appropriate index of refraction and thickness of the spacer is chosen for both the high pass filter (not shown) and the low pass filter (not shown), such that the high pass filter (not shown) permits passage of IR radiation and the low pass filter (not shown) permits passage of UV radiation. A processor (not shown) is in data communication with radiation source 90 and filtering system 92 to selectively allow the desired wavelength of radiation to propagate along optical path 88. The circuit enables high pass filter (not shown) when IR radiation is desired and enables the low pass filter (not shown) when UV radiation is desired.

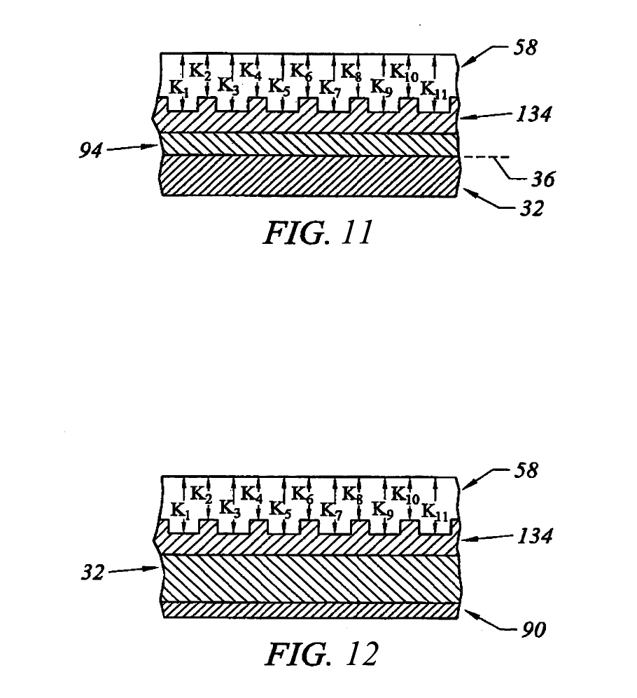

Referring to FIG. 11, substrate 32 may have one or more existing layers disposed thereon before deposition of imprinting layer 34. As a result, heating the conductive material may be problematic because the material from which the wafer is formed and/or the preexisting layers on the wafer, e.g., solidified imprinting layer 134, are substantially non-responsive to infrared radiation. As a result, very little energy transfer may occur, resulting in it being difficult to raise the temperature of the conductive material sufficient to achieve cross-linking.

To facilitate cross-linking of the conductive material in one of conformal layers 58 and 158, one of the layers included with substrate 32 may be an infrared absorption layer 94. Absorption layer 94 comprises a material that is excited when exposed to IR radiation and produces a localized heat source. Typically, absorption layer 94 is formed from a material that maintains a constant phase state during the heating process, which may include a solid phase state. Specifically, the IR radiation impinging upon absorption layer 94 causes an excitation of the molecules contained therein, generating heat. The heat generated in absorption layer 94 is transferred to the conductive material via conduction through the wafer and/or any intervening layer of material thereon, e.g., absorption layer 94 may be disposed on surface 36 so as to be disposed between substrate 32 and solidified imprinting layer 134. As a result, absorption layer 94 and substrate 32 provide a bifurcated heat transfer mechanism that is able to absorb IR radiation and to produce a localized heat source sensed by the conductive material in one of conformal layers 58 and 158. In this manner, absorption layer 94 creates a localized heat source on surface 36. To that end, absorption layer 94 may be deposited using any known technique, including spin-coating, chemical vapor deposition, physical vapor deposition, atomic layer deposition and the like. Exemplary materials may be formed from a carbon-based PVD coating, organic thermo set coating with carbon black filler or molybdenum disulfide (MoS₂) based coating.

Referring to FIG. 12, absorption layer 94 may be disposed on a side of substrate 32 disposed opposite to solidified imprinting layer 134. As a result, absorption layer 94 may be permanently or removably attached. Exemplary materials that may be employed as absorption layer 94 include black nickel and anodized black aluminum. Also, black chromium may be employed as absorption layer 94. Black chromium is typically deposited as a mixture of oxides and is used as a coating for solar cells.

Furthermore, as shown in FIG. 2, patterned mold 26 may be fabricated from any material, such as, but not limited to, fused-silica, quartz, silicon, organic polymers, siloxane polymers, borosilicate glass, fluorocarbon polymers, metal, and combinations of the above. However, in the present embodiment, the actinic radiation propagates through patterned mold 26. Therefore, it is desired that patterned mold 26 be fabricated from material that is substantially transparent to the actinic radiation. The plurality of features on patterned mold 26 are shown as recesses 28 extending along a direction parallel to projections 30 that provide a cross-section of patterned mold 26 with a shape of a battlement. However, recesses 28 and projections 30 may correspond to virtually any feature required to create an integrated circuit and may be as small as a few tenths of nanometers.

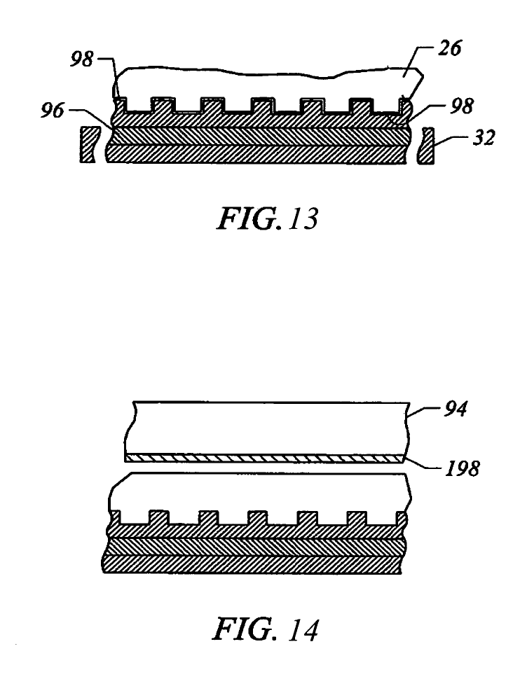

Referring to FIGS. 2 and 13, similarly, it may be desirable to provide substrate 32 with a planarized surface upon which to form imprinting layer 34. To that end, a primer layer 96 may be formed upon substrate 32. Primer layer 96 has proved beneficial when surface 36 of substrate 32 appears rough when compared to the features' dimensions to be formed in imprinting layer 34. Additionally, it has been found beneficial to deposit primer layer 96 when forming imprinting layer 34 upon a previously disposed patterned layer present on substrate 32. Primer layer 96 may also functions, inter alia, to provide a standard interface with imprinting layer 34, thereby reducing the need to customize each process to the material from which substrate 32 is formed. In addition, primer layer 96 may be formed from an organic material with the same etch characteristics as imprinting layer 34. Primer layer 96 is fabricated in such a manner so as to possess a continuous, smooth, relatively defect-free surface that may exhibit excellent adhesion to imprinting layer 34. An exemplary material to use to form primer layer 96 is available from Brewer Science, Inc. of Rolla, Mo. under the trade name DUV30J-6.

Referring to FIGS. 5 and 13, to reduce the probability that solidified imprinting layer 134 does not adhere to patterned mold 26, surface 50 may be treated with a low surface energy coating 98. Low surface energy coating 98 may be applied using any known process. For example, processing techniques may include chemical vapor deposition method, physical vapor deposition, atomic layer deposition or various other techniques, brazing and the like. In a similar fashion a low surface energy coating 198 may be applied to planarization mold 126, shown in FIG. 14. Typically, the surfactant has a surface energy associated therewith that is lower than a surface energy of the polymerizable material in the layer. An exemplary material and process by which to form the aforementioned surfactant is discussed by Bender et al. in MULTIPLE IMPRINTING IN UV-BASED NANOIMPRINT LITHOGRAPHY:RELATED MATERIAL ISSUES, Microelectronic Engineering pp. 61-62 (2002). The low surface energy of the surfactant provides the desired release properties to reduce adherence of either imprinting layer 34 or conformal layers 58 and 158 to patterned mold 26 or planarization mold 126. It should be understood that the surfactant may be used in conjunction with, or in lieu of, low surface energy coatings 98 and 198.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. A method of forming a patterning conductive layer on a substrate, said method comprising:
creating a multi-layered structure by solidifying a liquid layer to have a pattern including electrically insulative protrusions and recessions, defining a dielectric patterned layer, and forming, upon said patterned layer, a liquid conformal layer, and solidifying said liquid conformal layer to form a solidified electrically conductive conformal layer; and
removing a portion of said solidified electrically conductive conformal layer to expose regions thereof, with said regions being electrically insulated from adjacent regions of said solidified conductive conformal layer by one of said protrusions.

2. The method as recited in claim 1 wherein solidifying further includes said thermally curing said liquid conformal layer.

3. The method as recited in claim 1 wherein solidifying further includes said thermally curing said liquid conformal layer, with said liquid conformal layer being reflowed to provide a substantially smooth surface while undergoing curing.

4. The method as recited in claim 1 wherein solidifying further includes exposing said liquid conformal layer to actinic radiation.

5. The method as recited in claim 1 wherein forming further includes providing said liquid conformal layer with a conductive component selected from a set consisting of polyanyline, carbon-black and graphite.

6. The method as recited in claim 1 wherein creating further includes forming said conformal layer by spin-coating a polymerizable material on said patterned layer.

7. The method as recited in claim 1 wherein removing further includes subjecting said conductive conformal layer to a plasma etch.

8. The method as recited in claim 1 wherein creating further includes depositing a polymerizable fluid composition on said substrate and subjecting said polymerizable fluid composition to conditions to polymerize said polymerizable fluid composition, forming said dielectric patterned layer having opposed sides, one of which conforms to a shape of said substrate.

9. The method as recited in claim 1 wherein forming further includes spin-coating a conductive polymerizable material on said patterned layer, with curing further including curing said conductive polymerizable material while reflowing said conductive polymerizable material.

10. A method of patterning a substrate with a mold having a surface, said comprising:
placing a mold in superimposition with said substrate;
positioning a polymerizable fluid composition between said mold and said substrate to have said polyerizable fluid composition conform to a shape of said surface;
subjecting said polymerizable fluid composition to conditions to undergo polymerization to form a polymerized layer having opposed sides, one of which conforms to a shape of said surface;
forming a conductive conformal layer on of said polymerized layer; and
removing material in said conductive conformal layer to expose regions of said polymerized layer.

11. The method as recited in claim 10 wherein forming further includes spin-coating a conductive polymerizable material on said polymerized layer.

12. The method as recited in claim 10 wherein removing further includes subjecting said conductive conformal layer to a plasma etch.

13. The method as recited in claim 10 wherein forming further includes spin-coating a conductive polymerizable material on said polymerized layer and curing said conductive polymerizable layer while reflowing said conductive polymerizable layer.

14. The method as recited in claim 10 wherein forming further includes spin-coating a conductive polymerizable material on said polymerized layer and curing said conductive polymerizable layer while reflowing said conductive polymerizable layer to provide a solidified conductive polymerizable layer with a substantially planar surface.

15. The method as recited in claim 10 wherein subjecting further includes solidifying a relief structure in said polymerized layer, with said relief structure including protrusions and recessions with removing further including exposing said protrusions.

16. The method as recited in claim 10 wherein forming further includes forming said conductive polymerizable layer from a polymer material including a conductive element selected from a set consisting of polyanyline, carbon-black and graphite.

17. A method of patterning a substrate with a mold having a surface, said comprising:
placing said mold in superimposition with said substrate;
positioning a polymerizable fluid composition between said mold and said substrate to have said polyerizable fluid conform to a shape of said surface;
subjecting said polymerizable fluid composition to conditions to polymerize said polymerizable fluid composition, forming a polymerized layer having opposed sides, one of which conforms to a shape of said substrate;
spin-coating a conductive polymerizable material on said polymerized layer, forming a conductive conformal layer on said polymerized layer; and
reflowing said conductive conformal layer while curing said conductive conformal layer to provide a solidified conductive layer having a substantially smooth surface.

18. The method as recited in claim 17 further including removing material from said solidified conductive layer to expose regions of said polymerized layer.

19. The method as recited in claim 18 wherein removing further includes subjecting said solidified conductive layer to a plasma etch.

20. The method as recited in claim 17 wherein reflowing further includes reflowing said conductive polymerizable layer to provide said conductive polymerizable layer with a substantially planar surface.

21. The method as recited in claim 17 wherein subjecting further includes solidifying a relief structure in said polymerized layer, with said relief structure including protrusions and recessions with removing further including selectively removing portions of said conductive conformal layer structure to expose said protrusions.

22. The method as recited in claim 17 further includes forming said conductive polymerizable layer from a polymer material including a conductive element selected from a set consisting of polyanyline, carbon-black and graphite.
